(19) United States
(12) Patent Application Publication
(10) Pub. No.: US 2004/0243467 A1
(43) Pub. Date: Dec. 2, 2004

(54) System and method for facilitating distribution of incentives from a merchant to a parent

(75) Inventors: Jason Ewell, Ridgewood, NJ (US); Lionel Le Meur, New York, NY (US); Stephen J. Squeri, New York, NY (US); Brett M. Sussman, New York, NY (US); Anre Williams, South Orange, NJ (US)

Correspondence Address: SNELL & WILMER, ONE ARIZONA CENTER, 400 EAST VAN BUREN, PHOENIX, AZ, 850040001

(73) Assignee: American Express Travel Related Services Company, Inc.

(21) Appl. No.: 10/634,518

(22) Filed: Aug. 4, 2003

Related U.S. Application Data
(60) Provisional application No. 60/475,274, filed on Jun. 2, 2003.

(51) Int. Cl. G06F 17/60

(52) U.S. Cl. 705/14; 705/39

(57) ABSTRACT

A system for facilitating distribution of incentives from a merchant to a parent includes a financier and a merchant. The financier is in communication with the merchant, and the merchant is in communication with a subsidiary, which is financially related to a parent. The financier is configured to facilitate the receipt, maintenance and provision of incentive information regarding one or more incentives to be provided to the parent, where the incentive is configured to encourage one or more behaviors by said subsidiary. The merchant is configured to receive financial information from the subsidiary, forward the financial information to the financier, receive the incentive information from the financier, and provide one or more incentive to the parent. In various embodiments, the parent may be an employer or a guardian of the subsidiary, the merchant may be an airline, and the incentive may include a discount redeemable for travel services.

### CROSS REFERENCE TO RELATED APPLICATION

This application claims benefit from U.S. Provisional Patent Application Serial No. 60/475,274, filed Jun. 2, 2003, which is incorporated by reference in its entirety.

### FIELD OF INVENTION

The present invention generally relates to facilitating incentive offerings. More specifically, the present invention relates to systems and methods for facilitating integration of financial services and incentive offers wherein the incentive offers are configured to reward a parent organization for the behavior of one or more subsidiary.

### BACKGROUND OF THE INVENTION

During the last half of the twentieth century, and particularly the last twenty five years, many changes have occurred in the travel industry. For example, travel via aircraft has increased dramatically. Similarly, the number and variety of available destinations, and the venue and entertainment choices available at those destination, have also experienced significant growth. As a result of these increases in both volume and variety of travel-related goods and services, consumers may now enjoy more flexibility than ever as they make their choices in areas such as transportation mode, transporting carrier, destination, accommodation, meals, local transportation, and entertainment. This vast array of choices available to consumers has typically been the result and the cause of intense competition between today's providers of goods and services (i.e., merchants).

One obvious example of this increased competition may be found in the airline industry. In recent years, airlines have sought to overcome their customers' intense, focus on prices by mounting extensive campaigns to establish and improve consumer loyalty. One of the first manifestations of a loyalty system involved providing corporate discounts through negotiated contracts. Such loyalty systems, however, typically required the prior negotiation of one or more contracts and the presentation of a company identification number at the point of sale. Unfortunately, it was necessary that each traveler or other party making a reservation remember the number so that it could be provided at the point of sale and used to reference the negotiated loyalty agreement. Often, although eligible for incentives under an agreement, many travelers simply did not know and/or could not remember their number or the program, so they failed to receive their earned incentives. Moreover, the negotiated contracts often required minimum volume commitments from certain corporations and some of the corporations may have been reluctant to agree to such minimum commitments.

In addition to requiring each user to learn and remember an appropriate identifier in order to receive their earned incentives, existing discounts typically are not linked with any method of payment. Accordingly, today's incentive systems typically require some form of “manual” enforcement. This problem is particularly troublesome in the air travel industry wherein airline discounting is frequently implemented through travel agencies or other direct corporate contracts. These arrangement may include limited opportunities for a consumer to provide an effective means for identifying an incentive agreement. Moreover, even if an appropriate incentive agreement can be identified, difficulties often arise with respect to redemption of the incentives. For example, many policies require that either employees or their travel agents book the travel using a corporate identification number, and the booking processes may often include errors.

As with the recent growth in competition between providers of travel-related goods and services, dramatic increases in competition have arisen in many sectors of the economy. For example, providers of financial services (i.e., financiers) often compete more fiercely than ever to gain or maintain market share. As a result, financiers such as credit card issuers, banks, financial service providers, and the like, are continually seeking to enhance the services they provide to their clients. Airlines serve not only the end users of travel services (i.e., travelers), but also the corporations (on whose behalf many employees fly) and the travel agents (who facilitate the booking process). Similarly, financial service providers serve not only the consumers who use financial vehicles to facilitate their purchases, but also the merchants who accept their financial instruments as payment vehicles and the corporate clients who often assume responsibility for the transactions of their employees.

Similarly, other providers of goods and services (e.g., retailers such as automobile dealers, shopping clubs, grocery and clothing stores, home-improvement warehouses, and the like) (e.g., service providers such as dentists, automobile repair facilities, membership clubs, hotels, and the like) have developed a wide variety of incentives and rewards to encourage consumer loyalty. For more information on loyalty systems, transaction systems, electronic commerce systems and digital wallet systems, see, for example, U.S. Patent Application Ser. No. 09/836,213, filed on Apr. 17, 2001 by inventors Voltmer, et al. and entitled System And Method For Networked Loyalty Program; U.S. Continuation-In-Part Patent Application Ser. No. 10/027,984 was filed on Dec. 20, 2001 by inventors Ariff, et al. and is entitled System And Method For Networked Loyalty Program;

U.S. Continuation-In-Part Patent Application Ser. No. 10/010,947 filed on Nov. 6, 2001 by inventors Haines, et al. and entitled System And Method For Networked Loyalty Program; U.S. Continuation-In-Part Patent Application Ser. No. 10/084,744 filed on Feb. 26, 2002 by inventors Bishop, et al. and entitled System And Method For Securing Data Through A PDA Portal; the Shop AMEX™ system disclosed in U.S. Patent Application Serial No. 60/230,190 filed Sep. 5, 2000; the MR as Currency™ and Loyalty Rewards Systems disclosed in U.S. Patent Application Serial No. 60/197,296 filed on Apr. 14, 2000; U.S. Patent Application Serial No. 60/200,492 filed Apr. 28, 2000; U.S. Patent Application Serial No. 60/201,114 filed May 2, 2000; the digital wallet system disclosed in U.S. patent application Ser. No. 09/652,899 filed Aug. 31, 2000; the stored value card disclosed in U.S. patent application Ser. No. 09/241,188 filed on Feb. 1, 1999; the system for facilitating transactions using secondary transaction numbers disclosed in U.S. patent application Ser. No. 09/800,461 filed on Mar. 7, 2001, and also in related provisional U.S. Patent Application Serial No. 60/187,620 filed Mar. 7, 2000, Serial No. 60/200,625 filed Apr. 28, 2000 and Serial No. 60/213,323 filed May 22, 2000, all of which are herein incorporated by reference. Other examples of online membership reward systems are disclosed in Netcentives U.S. Pat. No. 5,774,870, issued on Jun. 30, 1998, and U.S. Pat. No. 6,009,412, issued on Dec. 29, 1999, both of which are hereby incorporated by reference.

In addition to the above-mentioned reward systems, service providers have in some limited cases joined together to offer combined incentives, effectively cross-selling each others goods or services. For example, credit card issuers and airlines have joined together to offer credit cards providing frequent-flier miles whenever the cards are used. One of the first such consumer co-brand cards involving an airline and a credit card issuer appeared in the marketplace around the 1980s timeframe. Since that time, however, the co-brand programs have typically been consumer-focused, with rewards accruing to the primary card member, even when such programs were used by small-businesses, or solely to the employee in programs linked to a corporate card. As such, the prior art co-brand programs focused primarily on gaining consumer loyalty and carried little incentive for the partnering corporation to increase the volume of transactions conducted using the cards.

As the quantity and variety of loyalty and reward systems has grown, so too has their complexity. As loyalty programs have grown in complexity, it has simultaneously become more difficult to isolate the net costs of the primary goods and/or services (e.g., what a flight might cost if no incentive were attached) from the net costs of the goods and/or services conveyed through the loyalty program (e.g., frequent flier miles). Further, where the costs associate with the purchase of specific goods or services are to be borne by someone other than the end user (e.g., by the end-user's employer or guardian), the responsible party will likely pay more for the primary goods and/or services than if no incentives were attached. This is because, in the end, the costs of the incentives will ultimately be born by those who pay for the primary goods and/or services. In effect, the employer or guardian (i.e., parent) will bear not only the costs of the purchased goods or services, but also the costs associated with the incentive or reward. For example, where an employee is able to choose which airline to use for employment-related travel, and where the expenses for that travel is to be paid by the employer, the employee is likely to base its decision at least in part on which airline offers the best incentives (e.g. free flights, upgrades, beverages, and the like) to the employee. Accordingly, the employee may be encouraged to make decisions without regard for the ,ultimate impact on the parent (e.g., that may be detrimental to the parent). While it is the employee who typically enjoys the benefits of the incentives, it is typically the parent who bears the real costs associated with both the incentive and the required goods or services.

In many cases, the providing of incentives could be viewed as bribes or kickbacks and may have the effect of impairing the impartiality of purchasers, or at least creating the appearance of impropriety with respect to the purchaser's impartiality. Such situations can invoke legal and ethical considerations, particularly for government officials, government procurement officers and the like. For example; where goods or services are purchased under government contract, it may be improper and/or may create the appearance of impropriety for a government official or procurement officer to receive an incentive in connection with such purchase. As a further consequence, under some circumstances, the receiving of incentives by some individuals may, therefore, have severe consequences for the parents of (e.g., employers of, or organizations associated with) the purchaser. As a result, ethical and legal considerations may preclude use of-many reward systems and may render such systems counter-productive. To date, the solution in such cases has often been to forego the collection of incentives altogether. Unfortunately, however, this solution may not be optimal for either the parent or the incentive provider.

### SUMMARY OF THE INVENTION

The present invention addresses many of the shortcomings of the prior art by providing systems and methods for facilitating integration of financial services and incentive offers where the incentive offers are configured to reward a parent organization for the behavior of one or more financially-related subsidiary. In a first aspect, an exemplary system for facilitating distribution of incentives-from a merchant to a parent includes a financier and a specific merchant, namely a carrier. The financier is in communication with the carrier, and the carrier is in communication with a subsidiary, which is financially related to the parent. The financier is configured to facilitate the receipt, maintenance and provision of incentive information regarding one or more incentives to be provided to the parent, where the incentive is configured to encourage one or more behaviors by said subsidiary.

In an exemplary embodiment, the carrier is configured to receive financial information from the subsidiary, forward the financial information to the financier, receive the incentive information from the financier, and provide one or more incentives to the parent. In various embodiments, the parent may be an employer or a guardian of the subsidiary, the carrier may be an airline, and the incentive may include a discount redeemable for travel services. The subsidiary may include an employee, relative, friend, charity, organization, company or any other entity or individual. In various exemplary embodiment, the financial information may be configured to identify a credit card account, a charge card account, or a debit card account. The financial information may be configured to settle a transaction involving one or more service provided by the carrier to the subsidiary, and the one or more incentive may be based at least in part on the one or more service.

In another aspect, an exemplary method for facilitating distribution of incentives from a merchant to a parent includes receiving, by a financier, incentive information regarding one or more incentives to be provided to a parent, where the one or more incentives are configured to encourage one or more behaviors by a subsidiary. An exemplary method also includes receiving, by a carrier, of financial information from the subsidiary, where the financial information is configured to settle a transaction involving one or more service provided by the carrier to the subsidiary. In addition, a method includes forwarding, by the carrier, of the financial information to the financier, providing, by the financier, of the incentive information, receiving, by the carrier, of the incentive information from the financier, and providing, by the carrier, one or more incentive to the parent, where the one or more incentive is based at least in part on the incentive information.

### BRIEF DESCRIPTION OF THE DRAWINGS

A more complete understanding of the present invention may be facilitated by derived by referring to the following detailed description considered in connection with the following drawings, in which like numerals represent like elements and in which:

FIG. 1 illustrates a schematic diagram of an exemplary prior art system;

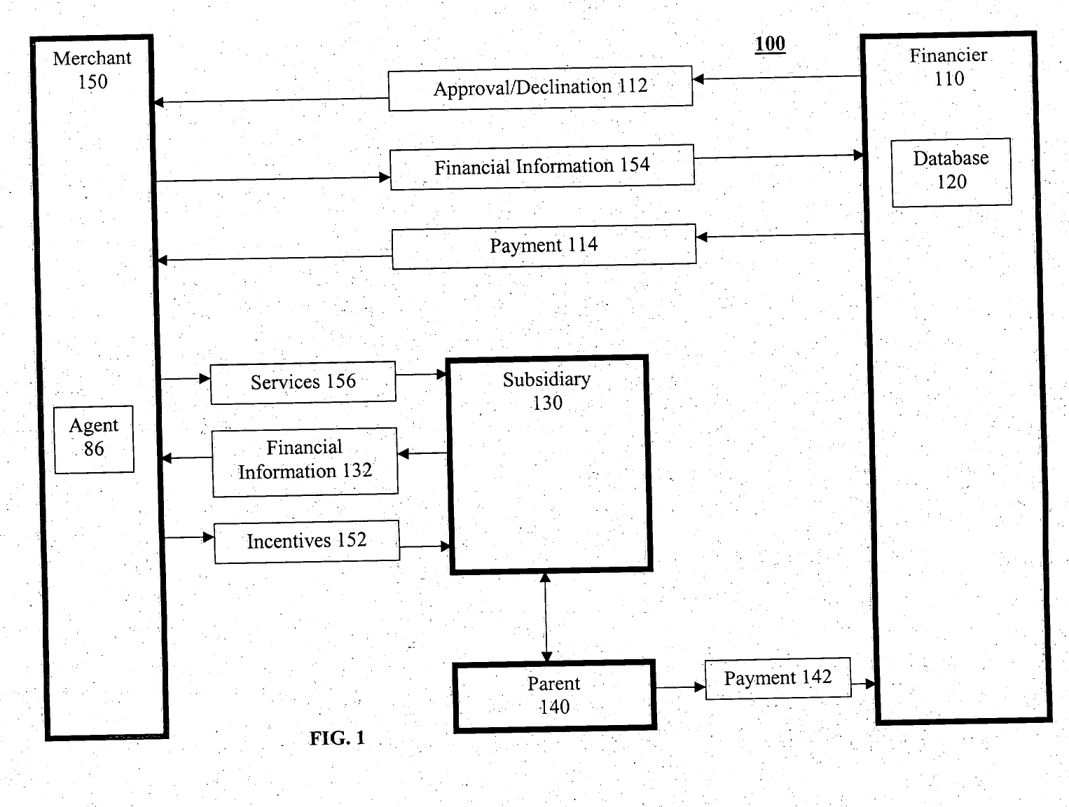

FIG. 2 illustrates a schematic diagram of a system for facilitating distribution of incentives from a merchant to a parent in accordance with an embodiment of the present invention; and

FIG. 3 illustrates a,u flow diagram of an exemplary method for facilitating distribution of incentives from a merchant to a parent in accordance with an embodiment of the present invention.

### DETAILED DESCRIPTION OF EXEMPLARY EMBODIMENTS

The present invention addresses many of the shortcomings of the prior art by providing systems and methods for facilitating integration of the provision of financial services by a financier and incentive offers by a merchant, where the incentive offers are configured to reward a parent organization for the behavior of one or more financially-related subsidiary. In accordance with various aspects of the invention, merchants may provide incentives either directly to parents or to clients of the parents. Accordingly, parents and their clients may accrue benefits associated with rebate programs, incentive programs, loyalty programs and other programs associated with the purchases by subsidiaries associated with the parents. The present invention is particularly relevant to rebate and incentive programs with hard-dollar savings. In addition, merchants may provide incentives directly to parents and/or their clients even though their only other connection with the parent or the client is through their business contact with the subsidiary and the financier of the subsidiary. The parent may include an employer, contractor, relative, friend, charity, organization, company, system, hardware, software or any other entity or individual. The subsidiary may include an employee, contractor, relative, friend, charity, organization, company, system, hardware, software or any other entity or individual. However, one skilled in the art will appreciate that, in accordance with the present invention, the parent, subsidiary, and merchant (or carrier) may include each other or the definitions and roles may be interchanged. As discussed more fully below, the present invention thereby provides many improvements over prior art systems.

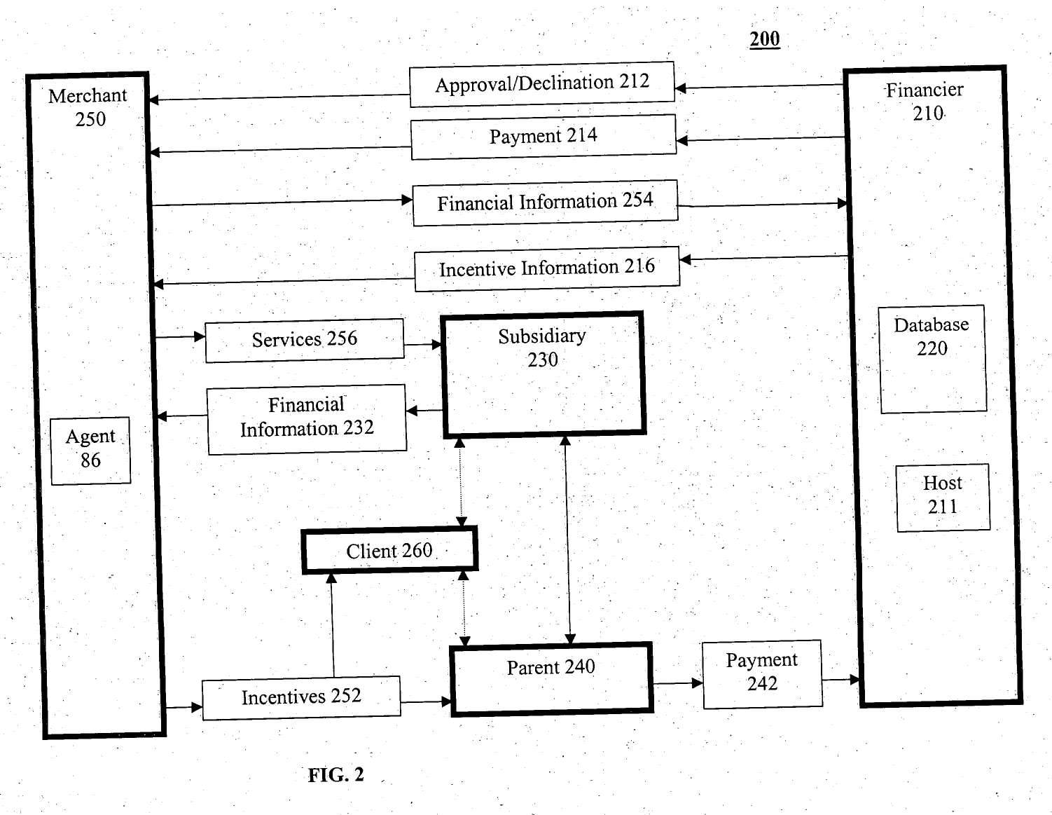

FIG. 2 illustrates a schematic diagram of a system 200 for facilitating distribution of incentives from a merchant to a parent in accordance with an exemplary embodiment of the present invention. With reference to FIG. 2, an exemplary system 200 includes a financier 210 and a merchant 250. Financier 210 is in communication with merchant 250, and merchant 250 is in communication with a subsidiary 230, which is related to a parent organization 240 (e.g., financially related). Financier 210, merchant 250, subsidiary 230, and parent organization 240 may include any person, organization, entity, charity, software, hardware and/or the like.

Financier 210 may comprise a database 220 and a host 211. Financier 220 is configured to facilitate the receipt, maintenance and provision of incentive information 216 regarding one or more incentives 252 to be provided to parent 240 or client 260 of parent 240, where the incentive 252 is configured to encourage one or more behaviors by subsidiary 230, parent 240, and/or client 260. Financier 210 may be configured to obtain and maintain its data in any .convenient manner. For example, it may periodically “ping” remote servers, receive or retrieve batch data at predetermined intervals, operate in an interrupt mode to receive significant updates, maintain communication links with one or more merchants 250 to facilitate real time updates, and/or the like. In addition, financier 210 may be configured to facilitate tracking of a parent's 240 spending (e.g., including that of all of its subsidiaries 230) on a particular product or service or class of products or services (e.g., airline) across all of its subsidiaries 230 (e.g., employees having corporate cards).

In operation, financier 210 may be in communication with merchant 250. Host 210 is also configured for communication with parent 240. In addition, merchant 250 is in communication with subsidiary 230, parent 240, and may also be in communication with client 260.

Communication among the parties in accordance with the present invention may be accomplished through any suitable communication protocol, such as, for example, a telephone or telephone network, a touch-tone telephone, a two-way pager, a reply pager, a home computer, a personal computer, a personal communication device, a personal communication services device, a digital communications device, a television, an interactive television, a digital television a personal digital assistant, a display telephone, a video telephone, a watch, a cellular telephone, a wireless telephone, a mobile telephone, a display cellular telephone, a facsimile machine, Intranet, Internet, point of interaction device (point of sale device, personal digital assistant, cellular phone, kiosk, etc.), online communications, off-line communications, wireless communications, local area network (LAN), wide area network (WAN), networked or linked devices, or the like. One skilled in the art will also appreciate that, for security reasons, any databases, systems, devices, servers, or other components of the present invention may consist of any combination thereof at a single location or at multiple locations, wherein each database or system includes any of various suitable security features, such as firewalls, access codes, encryption, decryption, compression, decompression, or the like.

To simplify the description of the invention herein, various embodiments of the invention are described as pertaining to a system, using a computer network, for facilitating communication among, for example, a financier 210, a merchant 250, a subsidiary 230, a host 211 (which may be integrated with financier 210), a database. 220 (which may also be integrated with financier 210), a parent 240 (which may be affiliated with subsidiary 230), a client 260 (which may be affiliated with parent 240 and subsidiary 230), and an agent 86 (which may be affiliated with merchant 250). It should be appreciated that the computing units may be connected with each other via a data communication network. If the network is in the nature of a public network, it may be advantageous to presume to network, it may be advantageous to presume the network to be insecure and open to eavesdroppers. For example, the network may compromise the Internet. In this context, the computers may or may not be connected to the internet at all times. For instance, the computer of subsidiary 230 and/or the computer of parent 240 may employ a modem to occasionally connect to the internet, whereas agent 86 or host 211 and/or financier 210 computing center may maintain an intermittent or permanent connection to the internet. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) the contents of which are hereby incorporated by reference.

The various computers associated with subsidiary 230, parent 240, financier 210, host 211, merchant 250, agent 86, and client 260 are suitably interconnected via a network, referred to as a transaction network. The transaction network may compromise presently known proprietary networks for use with on-line transactions, such as transactions for credit cards, debit cards, and other types of financial/banking, card transactions. The transaction network is a preferably closed network and may be assumed to be secure from VisaNet® and the Veriphone® networks. The parties may interact with the system via any input device such as a keyboard, mouse, kiosk, personal digital assistant, handheld computer (e.g., Palm Pilot®), cellular phone, any suitable communication or data input modality.

The various systems components may be suitably coupled to the transaction network via data links including a variety of communications media and protocols such as, for example, a connection to an Internet Service Provider (ISP) over the local loop as is typically used in connection with standard modem communication, cable modem, Dish networks, ISDN, Digital Subscriber Line (DSL), or various wireless communication methods. Travel-related service provider systems may reside within a local area network (LAN) which interfaces to the transaction network via a leased line (T1, D3, etc.) or other desired communication methods. See, e.g., Gilbert Held, Understanding Data Communications (1996), hereby incorporated by reference.

In on-line implementations of the instant invention, each participant is equipped with a computing device. Subsidiary/230, parent 240, and client 260 may be equipped with a computing unit in the form of a personal computer, although other types of computing units may be used including laptops, notebooks, hand held computers, set-top boxes, touch-tone telephones, and the like. Financier 210, host 211, merchant 250, and agent 86 may be equipped with a computing unit such as a computer-server, although other implementations are contemplated by the invention. Any of the participants may be implemented as a computer, which may be a main frame computer or which may be implemented in other forms, such as minicomputers, PC servers, a network of computers or the like.

System 200 may also include a suitable website or other Internet-based graphical user interface which is accessible by users. In one embodiment, the Internet Information Server, Microsoft Transaction Server, and Microsoft SQL Server, may be used in conjunction with the Microsoft operating system, Microsoft NT Web server software, a Microsoft SQL database system, and a Microsoft Commerce Server. Additionally, components such as Access Sequel Server, Oracle, MySQL, Intervase, etc., may be used to provide an ADO-compliant database management system. The term “webpage” as it is used herein is not meant to limit the type of documents and applications used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like.

The various servers employed in the system of the present invention may comprise any suitable hardware, software, and networking components to provide an appropriate interface to a network. In addition, the servers may be configured to manage databases such as, for example, the database of financier 220. In one embodiment, servers may include Sun Ultra SPARC Enterprise 250 and 450 servers which may be used in conjunction with a Sun Solaris 7 or Linux operating system. Apache web server software, and an Oracle 8 or MySQL database system. Of course, particular hardware and software components used in servers may vary widely from embodiment to embodiment. Furthermore, servers may represent a “cluster” or group of separate computer systems providing the functionalities described herein.

A variety of conventional communications media and protocols may be used for the various data links. Such links might include, for example, a connection to an Internet Service Provider (ISP) over a local loop as is typically used in connection with standard modem communication, cable modem, Dish networks, ISDN, Digital Subscriber Line (DSL), or various wireless communication methods. In addition, various system components may independently, separately, or collectively, reside within a local area network (LAN) which interfaces to network via a leased line (T1, D3, etc.). See, e.g., GILBERT HELD, UNDERSTANDING DATA COMMUNICATIONS (1996), hereby incorporated by reference.

In an exemplary system, financier 210 includes a database which may compromise a plurality of data sectors for maintaining data relating to financial accounts, parents, subsidiaries, clients, merchants, goods, services, incentives, and methodologies and/or algorithms for determining incentives. Such information may include, for example, card hierarchy, associations between employees and corporations, associations between employees and sub-groups within a corporation, company address, cardmember address, account identification numbers, card identification numbers, charge volume summaries, merchant locations of charge volume and/or the like.

Various databases 220 useful in the system 200 of the present invention may include graphical, hierarchical, relational, object-oriented or other database configurations and may be maintained on a local drive, a local server, or on a separate computer coupled to a server via a local area or other network. In one embodiment, the database may be a collection of ASCII or other text files stored on a local drive of a server. Subsidiary account information may be suitably retrieved from the database and provided to a participant, upon request via a server application, as described more fully below. Common database products that may be used to implement the databases include DB2 by IBM (White Plains, N.Y.), various database products available from Oracle Corporation (Redwood Shores, Calif.), Microsoft Access by Microsoft Corporation (Redmond, Wash.), or any other suitable database product.

Moreover, the databases 220 may be organized in any suitable manner, for example as data tables or lookup tables. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in preselected databases or data sectors.

More particularly, a “key field” partitions the database according to the high-level class of objects defined by the key field. For example, certain types of data may be designated as a key field in a plurality of related data tables, and the data tables may then be merged on the basis of the type of data in the key field. In this regard, the data corresponding to the key field in each of the merged data tables is preferably the same or of the same type. However, data tables having similar, though not identical, data in the key fields may also be merged by using AGREP, for example.

Referring again to FIG. 2, in an exemplary embodiment, merchant 250 is configured to receive financial information 232 from subsidiary 230, forward financial information 254 to financier 210, receive incentive information 216 from financier 210, and provide one or more incentives 252 to parent 240 or client 260 of parent 240, where the incentive 252 is configured to encourage one or more behaviors by subsidiary 230, parent 240, and/or client 260. In various embodiments, parent 252 may be an employer or a guardian of subsidiary 230.

In an exemplary embodiment, merchant 250 may be an airline, and incentive 252 may include a discount redeemable for travel services 256. In various exemplary embodiments, financial information 232 may be configured to identify a credit card account, charge card account, debit card account, or other financial payment or guarantee vehicle facilitated by financier 210. In one embodiment, the subsidiary does not need to include an account number in the financial information provided to the merchant because the account number and other similar information may be acquired and transmitted automatically at the point-of-sale when a transaction card (e.g., corporate charge card) is used. The financial information 232 may be configured to settle a transaction involving one or more services 256 provided by merchant 250 to subsidiary 230. It should be noted that one or more incentive 252 may be based at least in part on one or more service 256.

In an exemplary embodiment, system 200 facilitates rewarding one or more parents 240 for the behavior of one or more subsidiaries 230. The system may also facilitate provision of a card loyalty program, in which a hard-dollar discount may fully or partially accrue to parent 240. In one embodiment, system 200 facilitates a co-branded corporate card program targeted at parents 240 of a particular size (e.g., middle market companies) where those parents may be seeking opportunities to save on their expenses associated with s specific class of merchants (e.g., travel expenses) by shifting and consolidating their spending within that industry (e.g., airlines) to a preferred merchant (i.e., a partner airline). More specifically, the system 200 of the present invention may facilitate tracking of a parent's 240 spending (e.g., including that of all of its subsidiaries 230) on a particular product or service or class of products or services (e.g., airline) across all of its subsidiaries (e.g., employees having corporate cards). The system 200 may also be configured to facilitate providing incentives 252 (e.g., a rebate) only periodically (i.e., upon the passage of a predefined time interval (e.g., the end of each quarter) and may provide reporting and data gathering via a webpage on the internet or any other network communication. It should be noted that incentive 252 may be provided via check or electronic funds transfer to a company account.

In one embodiment, incentive 252 may be applied selectively to certain flights/fare classes and/or all flights/fare classes. The amount of incentive 252 accrued on each ticket may vary depending various factors, such as, for example, whether parent 240 has a pre-existing relationship with the merchant 250, the extent of that relationship, the existing discount associated with the relationship, existing travel agency deals (e.g., deals previously negotiated with the carrier on behalf of the travel agency's customer base), any future potential or promises of the foregoing examples, and/or the like. System 200 may also facilitate provision of incentive 252 in the form of parent “bonus” points automatically provided in a “parent-level” loyalty program. In accordance with this embodiment, the incentive 252 (e.g., points earned) may be based on spending of either subsidiary 230 or aggregate parent 240 and subsidiary 230, or any combination of parents 240 and subsidiaries 230. Such incentives 252 may be generated and tracked automatically by financier 210 such that neither parent 240 nor subsidiary is required to provide a specific “loyalty program number.”

In one exemplary system 200, parents 240 may be eligible for a back-end rebate on first class, business class and full fare coach tickets purchased from a predetermined merchant 250. An exemplary incentive 252 may include a rebate of 10% if not combined with any other point-of-sale offer (agency or corporate contract), 5% if combined with any other point-of-sale offer (agency or corporate contract) and 2.5% if combined with a current offer from the merchant or the financier. Subsidiaries 230 and parents 240 may also receive additional incentives for every incremental dollar amount (e.g., $20) spent on a specific merchant 250, in addition to a standard incentive such as a point award. Incentives 252 may also be based on fare type (e.g., for P, F, J, Y, A, B and H fares, a rebate may be applicable to the first specific amount of spending at the merchant 250 within a predetermined time period (e.g., a calendar year). Incentives 252 may also be applicable to contracts with parent 240 after a predefined transition period.

In an exemplary embodiment, financier 210 may be configured to compile spending on a predefined set of subsidiaries 230 and roll-up (i.e., accumulate) incentives 252 due the parent 240. The system 200 may be configured to retain underlying liability arrangements (e.g., joint and several liability benefits and options) associated with the financial arrangements between the participants as well as the hierarchal reporting of such financial arrangements. Accordingly, in one embodiment, financial information 232 may not cause parent 240 to be responsible for payment for the transactions of subsidiary 230 even though incentives 252 may nevertheless be provided to a parent 240. Incentives 252 may also be configured to encourage the purchase of certain types of fares and behavior on, for example, a dollar of “flown” charges, excluding taxes, fees and surcharges. As such, the system 200 may help build loyalty to both a financier 110 and a specific merchant 250. Further, the system may encourage compliance of subsidiaries 230 with policies established by parents 240 and have a direct positive impact on total charge volume.

In accordance with the present invention, the term “host” contemplates the hosting functions described herein. In addition, the term “host” as used herein refers to the type of company, institution, or organization which performs the hosting function, such as financiers, banks, credit card transaction card and companies, card sponsoring companies, third party issuers under contract with such financial and information institutions, data management institutions, search engines, and internet service providers. It should also be noted that other participants may be involved in some phases of transactions related to facilitation of transactions involving the accounts, such as one or more intermediary settlement institution, but these participants are not shown in the drawings.

Host 211 may include any suitable combination of hardware and software components configured to allow a financier 210 and a merchant 250 to communicate with the host 211 over the network. For example, host 211 might may include a standard personal computer (PC) comprising a CPU, monitor, storage, keyboard, mouse, and communication hardware appropriate for the given data link (e.g., V.90 modem, network card, cable modem, etc.). In alternate embodiments, host 211 may be a personal data assistant (PDA) capable of manipulating images and communicating with technology provider 220. Host 211 may typically include an operating system (e.g., Windows 95/98/2000, Linux, Solaris, MacOS, and/or the like) as well as varous conventional support software modules and drivers typically associated with such computers. Host 211 may also include application software configured to communicate over a network with merchant 250. For example, one such application software may include a world wide web (WWW) browser or other suitable communication software. In an exemplary embodiment, host 211 includes a conventional Internet browser application that operates in accordance with appropriate (e.g., HTML and HTTP) protocols such as Netscape Navigator (available from the Netscape Corporation of Mountain View, California) or Microsoft Internet Explorer (available from the Microsoft Corporation of Redmond, Wash.).

As those skilled in the art will appreciate, the computer associated with financier 210 may include an operating system (e.g., Windows NT, 95/98/2000, Linux, Solaris, etc.) as well as various conventional support software and drivers typically associated with computers. The invention, however, may also be implemented in conjunction with any suitable personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention may be implemented with TCP/IP communications protocols, the invention may also be implemented using IPX, Appletalk, IP-6, NetBIOS, OSI or any number of existing or future protocols. The system contemplates the use, sale or distribution of any goods, services or information over any network having similar functionality described herein. Computers can be in a home or business environment with access to the transaction network.

The various system components discussed herein may include one or more of the following: a host server or other computing systems including a processor for processing digital data; a memory coupled to said processor for storing digital data; an input digitizer coupled to the processor for inputting digital data; an application program stored in said memory and accessible by said processor for directing processing of digital data by said processor; a display device coupled to the processor and memory for displaying information derived from digital data processed by said processor; and a plurality of databases. Various databases used herein may include data regarding the financier 210, host 211, merchant 250, agent 86, subsidiary 230, parent 240, and/or client 260, and/or like data useful in the operation of the present invention. Limitations, data, or restrictions, requests, and the like, may be communicated to a host via any suitable network, email webpage, voice response unit or customer service line via customer service representatives. Such information and data may also be transmitted to the host via one or more of a telephone, a touch-tone telephone, a two-way pager, a reply pager, a home computer, a personal computer, a personal communication device, a personal communication services device, a digital communications device, a television, an interactive television, a digital television, a personal digital assistant, a display telephone, a video telephone, a watch, a cellular telephone, a wireless telephone, a mobile telephone, a display cellular telephone, and a facsimile machine.

Merchant 250 may include a network of point of sale devices, configured to communicate with host 211. In this context, a point of sale device may be any device suitable for receiving, processing, transmitting, and/or displaying data or information.

Access to the benefits of the system, and financial transfers or payments made in connection with transactions facilitated by the system, may themselves be facilitated through use of an account number or other information 232, 254 which identifies a user or a financial or other account of a user. An “account number,” as used herein, includes any device, code, or other identifier and/or indicia suitably configured to allow a subsidiary 230 or parent 240 to access, interact with, or communicate with the system such as, for example, one or more of an authorization/access code, a personal identification number (PIN), an Internet code, other identification code, and/or the like which may optionally be located on or associated with a rewards or incentives card, charge card, credit card, debit card, prepaid card, telephone card, smart card, magnetic stripe card, bar code card, or an associated account. Such an account number may be distributed and stored in any form of plastic, electronic, magnetic, and/or optical device capable of transmitting or downloading data from itself to a second device.

A subsidiary's 230 or parent's 240 account number may be, for example, a sixteen-digit credit issuer's identifier such as a credit card number, although each credit provider has its own numbering systems such as the fifteen-digit numbering system used by comply with a standardized format such as a sixteen-digit format using four spaced sets of numbers (e.g., as represented by the number “0000 0000 0000 0000”). In an exemplary embodiment, the first five to seven digits may be reserved for processing purposes and identify the issuing bank, card type, etc. In this example, the last (sixteenth) digit may be used as a sum check for the sixteen-digit number. The intermediary eight-to-ten digits may be used to uniquely identify subsidiary 230 or parent 240.

It should be noted that same aspects of the system of the present invention may at times require acquisition or verification of the identity of subsidiary 230 or merchant 250. Host 211 may accomplish the process of obtaining and/or verifying the identity of subsidiary 230 or merchant 250 through a variety of methods known in the art including, but not limited to, the use of private databases, credit bureau databases, transmission of biometric data, transmission of “hand-shake” data (i.e., smart card signature, challenge/response, etc) and/or the like. Examples of online authentication are disclosed in U.S. Ser. No. 09/952,490 “Microchip-Enabled Online Transaction System”, filed Sep. 12, 2001, by inventors Anant Nambiar and Geoffrey Stem, which is hereby incorporated by reference.

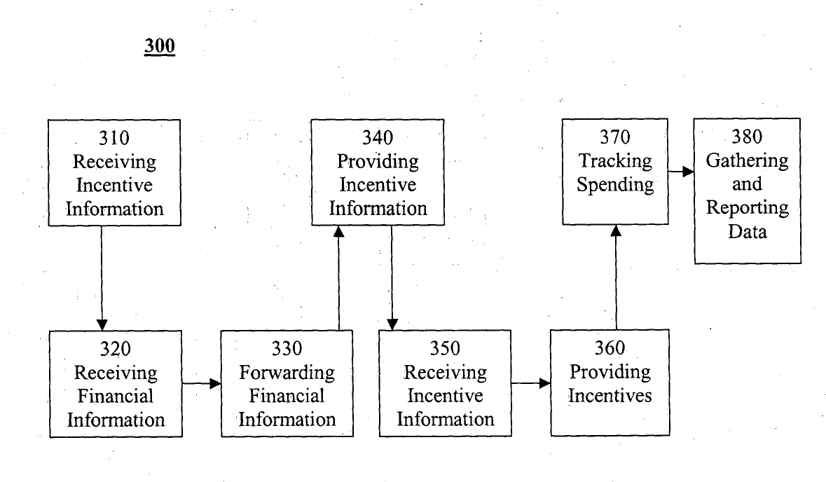

Referring now to FIG. 3, a flow diagram 300 of an exemplary method for facilitating distribution of incentives 252 from a merchant 250 to parent 240 or client 260 of parent 240 includes receiving (step 310), by financier 210, incentive information 216 regarding one or more incentives 252 to be provided to parent 240 or client 260 of parent 240, where the one or more incentives 252 are configured to encourage one or more behaviors by subsidiary 230, parent 240, and/or client 260. An exemplary method 300 also includes receiving (step 320), by merchant 250, financial information 232 from subsidiary 230, where financial information 232 is configured to settle a transaction involving one or more service 256 provided by merchant 250 to subsidiary 230. In addition, method 300 includes forwarding (step 330), by merchant 250, financial information 254 to financier 210, providing (step 340), by financier 210, incentive information 216, receiving (step 350), by merchant 250, of incentive information 216 from financier 210, and providing (step 360), by merchant 250, one or more incentives 252 to parent 240 or client 260 of parent 240, where the one or more incentives 252 is based at least in part on the incentive information 216.

In an exemplary embodiment, method 300 facilitates rewarding one or more parents 240 for the behavior of one or more subsidiaries 230. Method 300 may also be configured to facilitate provision of a card loyalty program, in which a hard-dollar discount may fully or partially accrue to parent 240. In one embodiment, method 300 facilitates a co-branded corporate card program targeted at parents 240 of a particular size (e.g., middle market companies) where those parents 240 may be seeking opportunities to save on their expenses associated with a specific class of merchants 250 (e.g., travel expenses) by shifting and consolidating their spending within that industry (e.g., airlines) to a preferred merchant (i.e., a partner airline). More specifically, the method 300 may include tracking (step 370) a parent's 240 spending (e.g., including that of all of its subsidiaries 230) on a particular product or service or class of products or services (e.g., airline) across all of its subsidiaries 230 (e.g., employees having corporate cards).

In an exemplary embodiment, the step of providing incentives 252 (step 360) may be performed only periodically (i.e., upon the passage of a predefined time interval (e.g., the end of each quarter). In, addition, an exemplary method may include the step of providing reporting and data gathering via a webpage on the internet or any other network communication (step 380). It should be noted that the step of providing incentives 252 (step 360) may be performed by providing a check or electronic funds transfer to a financial account of parent 240 or client 260.

In one embodiment, the step of providing incentives (step 360) includes determining the magnitude or type of incentives 252 to be provided based only on certain pre-selected flights and/or fare classes and/or combinations of flights and/or fare classes. In addition, this step of determining the magnitude or type of incentives 252 may depend upon other various factors, such as, for example, the volume and/or type of services 256, whether parent 240 has a pre-existing relationship with the merchant 250, the extent of that relationship and the existing discount associated with the relationship. This step (step 360) may also be configured to facilitate provision of incentive 252 in the form of parent “bonus” points, which may be automatically provided in a “parent-level” loyalty program. In accordance with this embodiment, the incentive 252 (e.g., points earned) may be based on spending of either subsidiary 230 or aggregate parent 240 and subsidiary 230, or any combination of parents 240 and subsidiaries 230. Accordingly the step of gathering data (step 380) may be configured so that incentives 252 may be generated and tracked automatically by financier 210 such that neither parent 240 nor subsidiary is required to provide a specific “loyalty program number.” In an exemplary embodiment, the step of reporting and data gathering (step 380) may be configured to facilitate compiling spending on a predefined set of subsidiaries 230 and rolling-up (i.e., accumulating) incentives 252 due the parent 240. Also, method 300 may be configured to facilitate retaining underlying liability arrangements (e.g., joint and several liability benefits and options) associated with the financial arrangements between the participants as well as the hierarchal reporting of such financial arrangements. Accordingly, in one embodiment, financial information 232 may not cause parent 240 to be responsible for payment for the transactions of subsidiary 230 even though incentives 252 may nevertheless be provided to a parent 240.

In one exemplary method 300, the step of providing incentives (step 360) may be configured so that parents 240 may receive a back-end rebate on first class, business class and full fare coach tickets purchased from a predetermined merchant 250. The step of providing incentives (step 360) may also be configured so that an exemplary incentive 252 may include a rebate of 10% if not combined with any other point-of-sale offer (agency or corporate contract), 5% if combined with any other point-of-sale offer (agency or corporate contract) and 2.5% if combined with a current offer from the merchant or the financier. Still further, the step of providing incentives (step 360) may also be configured so that subsidiaries 230 and parents 240 may receive additional incentives for every incremental dollar amount (e.g., $20) spent, on a specific merchant 250, in addition to a standard incentive such as a point award. Moreover, the step of providing incentives (step 360) may be configured so that incentives 252 may be configured to encourage the purchase of certain types of fares and behavior on, for example, a dollar of “flown” charges, excluding taxes, fees and surcharges. As such, the system 200 may help build loyalty to both a financier 110 and a specific merchant 250. Further, the system may encourage compliance of subsidiaries 230 with policies established by parents 240 and have a direct positive impact on total charge volume. Finally, the step of providing incentives (step 360) may be configured so that incentives 252 may be based on fare type (e.g., for P, F, J, Y, A, B and H fares, a rebate may be applicable to the first specific amount of spending at the merchant 250 within a predetermined time period (e.g., a calendar year), or so that incentives 252 may also be applicable to contracts with parent 240 after a predefined transition period.

In the foregoing specification, the invention has been described with reference to specific embodiments. However, it will be appreciated that various modifications and changes can be made without departing from the scope of the present invention as set forth in the claims below. For example, various processing steps may be combined or eliminated as required, such as for example, calculating a magnitude or type of incentive. Further, various system elements described herein may be eliminated, and various steps may be performed by one or more of the elements described herein, such as for example, permitting the merchant to communicate directly with financier 210 independently of a POS device. In addition, other suitable elements may be substituted for the elements described herein, or inserted between the connecting lines of the embodiments set forth, without departing from the scope of this invention. Further still, the specification and figures are to be regarded in an illustrative manner, rather than a restrictive one. As such, any modifications resulting in a system which is suitable for practicing the invention are intended to be included within the scope of the invention. Accordingly, the scope of the invention should be determined by the appended claims and their legal equivalents, rather than by the examples given above. For example, the steps recited in any of the method or process claims may be executed in any order and are not limited to the order presented in the claims.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control, devices. Similarly, the software elements of the present invention may be implemented with any programming or scripting language such as C, C++, Java, COBOL, assembler, PERL, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography, please review a text written by Bruce Schieier, which is entitled “Applied Cryptography: Protocols, Algorithms, And Source Code In C,” published by John Wiley & Sons (second edition, 1996), which is hereby incorporated by reference.

Other systems that may be integrated with, or layered on, the present invention include, for example, other loyalty systems, transaction systems, electronic commerce systems and digital wallet systems such as, for example, the Shop AMEX™ system as disclosed in Serial No. 60/230,190 filed Sep. 5, 2000; the MR as Currency™ and Loyalty Rewards Systems disclosed in Ser. No. 09/834,478 filed on Apr. 13, 2001; a Digital Wallet System disclosed in U.S. Ser. No. 09/652,899 filed Aug. 31, 2000; a Stored Value Card as disclosed in Ser. No. 09/241,188 filed on Feb. 1, 1999; a System for Facilitating Transactions Using Secondary Transaction Numbers disclosed in Ser. No. 09/800,461 filed on Mar. 7, 2001; Methods and Apparatus for Conducting Electronic Transactions disclosed in Serial No. 60/232,040 filed Sep. 12, 2000, all of which are hereby incorporated by reference. Other examples of online reward or incentive systems are disclosed in U.S. Pat. No. 5,774,870, issued on Jun. 30, 1998, and U.S. Pat. No. 6,009,412, issued on Dec. 29, 1999, both of which are hereby incorporated by reference. Additional information relating to smart card and smart card reader payment technology is disclosed in Serial No. 60/232,040, filed on Sep. 12, 2000, and U.S. Pat. Nos. 5,742,845; 5,898,838 and 5,905,908, owned by Datascape; which are hereby incorporated by reference. Moreover, additional information related to online privacy and anonymity systems may be found at www.PRIVADA.COM, which is hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, and application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

As will be appreciated by one of ordinary skill in the art, the present invention may be embodied as a method, a data processing system, a device for data processing, an integrated circuit, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create system and method for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of system and method for performing the specified functions, combinations of steps for performing the specified functions, and program instruction for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical.”

What is claimed is:

1. A system comprising a financier and a merchant for facilitating distribution of incentives from a merchant to a parent:
said financier is in communication with said merchant, said merchant is in communication with a subsidiary, and said subsidiary is financially related to a parent;
said financier is configured to facilitate the receipt, maintenance and provision of incentive information regarding one or more incentives to be provided to said parent, said incentive configured to encourage one or more behaviors by said subsidiary;
said merchant is configured to receive financial information from said subsidiary, forward said financial information to said financier, receive said incentive information from said financier, and provide one or more incentive to said parent, said one or more incentive based at least in part on said incentive information.

2. The system of claim 1, wherein said parent is an employer of said subsidiary.

3. The system of claim 1, wherein said parent is a guardian of said subsidiary.

4. The system of claim 1, wherein said merchant is an airline.

5. The system of claim 4, wherein said incentive comprises one or more discounts redeemable for travel services.

6. The system of claim 1, wherein said financial information is configured to identify a credit card account.

7. The system of claim 1, wherein said financial information is configured to identify a charge card account.

8. The system of claim 1, wherein said financial information is configured to identify a debit card account.

9. The system of claim 1, wherein said financial information is configured to settle a transaction involving one or more service provided by said merchant to said subsidiary and said one or more incentive is based at least in part on said one or more service.

10. A method for facilitating distribution of incentives from a merchant to a parent wherein the merchant comprises the steps of:
receiving financial information from a subsidiary, said financial information configured to settle a transaction involving one or more service provided by said merchant to said subsidiary;
forwarding said financial information to said financier, wherein said financier provides said incentive information regarding one or more incentives to be provided to a parent, said one or more incentives configured to encourage one or more behaviors by a subsidiary;
receiving said incentive information from said financier; and
providing one or more incentive to said parent, said one or more incentive based at least in part on said incentive information.
